(19) United States
(12) Patent Application Publication
(10) Pub. No.: US 2010/0207086 A1
(43) Pub. Date: Aug. 19, 2010

(54) CABLE LIFTING APPARATUS

(76) Inventors: Juan Julian Asensio Bazterra, Lazkao (ES); Enrique Del Pozo Polidoro, Lazkao (ES)

Correspondence Address: WENDEROTH, LIND & PONACK, L.L.P., 1030 15th Street, N.W.,, Suite 400 East, Washington, DC, 20005-1503, US

(21) Appl. No.: 12/680,007

(22) PCT Filed: Sep. 26, 2008
(86) PCT No.: PCT/ES08/00612

§ 371 Date: Mar. 25, 2010

(30) Foreign Application Priority Data
Sep. 28, 2007 (ES) P200702546

(51) Int. Cl. B66D 1/74; B66D 1/50

(52) U.S. Cl. 254/333; 254/356

(57) ABSTRACT

The invention relates to a cable lifting apparatus for lifting people or loads, including a traction sheave provided with a peripheral groove housing a suspension cable against which rollers apply a pressure in order for the traction sheave to perform the pulling function thereof. The apparatus is designed such that the radial load on the cable is a function of the load to be lifted and of the torque applied by a pinion mounted at the output of the reduction power unit and meshed with a gear wheel integrally connected to, and rotatably concentric with, the traction sheave. The described apparatus allows using a variable number of cables, either by means of the use of a modified sheave provided peripherally with as many grooves as there are cables and having an independent group of pressure rollers for each cable or through the formation of grooves between portions separated by notches made in radial planes between successive portions and having a single group of pressure rollers for all of the cables.

### OBJECT OF THE INVENTION

The present invention relates to a cable lifting apparatus, providing essential novel features and considerable advantages with respect to the systems known and used for the same purposes in the current state of the art.

More particularly, the invention relates to a cable lifting apparatus comprising one or several drive sheaves and one or several continuous cables (as many as there are sheaves), in which the load section of each cable passes through the groove of sheave existing around the periphery of each respective one of the drive sheaves to which it is associated, pressed by several rollers mounted according to the peripheral direction of each sheave, whereas the loose section of each cable exits through the respective groove of the sheave behind the pressure rollers.

The field of application of the invention is obviously comprised in the industrial sector dedicated to the design, manufacture and assembly of lifting apparatuses, generally for lifting loads and for lifting people.

### BACKGROUND AND SUMMARY OF THE INVENTION

Different types of lifting apparatus systems designed based on principles similar to those described above are known in the current state of the art. This is the case of, for example, those known through earlier patent documents identified as ES-0553097, U.S. Pat. No. 491,333 or U.S. Pat. No. 5,090,666.

As mentioned, the identified documents describe systems and apparatuses intended for providing devices that can be applied to lifting loads and/or people. However, in all of them there is an equivalent operating principle which consists of the fact that a cable is passed through a sheave, and at a point of the periphery of the sheave radial pressure is applied on the cable by means of rollers pressing the cable against the sheave.

In the first two documents, the pressure exerted by pinch wheels on the drive sheave is done as a result of the presence of a compressed spring, whereby radial pressure is exerted on the cable which pressure is always the same regardless of the load to be lifted. This solution has the drawback that the cable experiences constant radial stresses equivalent to those of the maximum load to be lifted or withstood, whereby increasing the wear of said cable and reducing its service life.

The third mentioned document describes a system in which the radial pressure exerted on the cable is a function that depends on the load to be lifted, whereby reducing the wear of the cable and increasing its service life in comparison to the solutions of the first two documents.

The present invention is intended for a cable lifting apparatus in which the pressure exerted on the cable depends, as in the mentioned case of the last document, on the load to be lifted, but with the particularity that it is affected by two different factors. The first factor is provided directly by the load to be lifted, whereas the second factor derives from the tangential reaction of the drive pinion mounted at the output of the reducer, meshed with a crown gear integral with the traction sheave. By means of this dual effect, an implementation can be carried out in which the angle of the groove the traction sheave is provided with can be of larger dimensions than that in sheaves of the traditional embodiments, which further reduces the wear of the cable and also elongates the service life of said cable.

Providing a lifting apparatus in which multiple cables are implemented, thereby considerably increasing the safety of lifting people and loads, is also an object of the present invention.

According to the invention, the pinching effect of the rollers on the suspension cable is achieved as a result of providing a rotating box containing the gears and the drive sheave. Since the output shaft of the reducer coincides with the rotating shaft of the box, the tangential reaction occurring in the periphery of the pinion associated with the output of the reducer, due to the torque applied by the reducer (which always acts in the same direction, either as a motor or as a brake), is vectorially added to the reaction due to the suspension cable, which allows modulating the force exerted by the pressure rollers, precisely adjusting it to its optimal value both from the point of view of the absence of sliding and from the point of view of greater durability of the cable.

### BRIEF DESCRIPTION OF THE DRAWINGS

These and other features and advantages of the invention will be more clearly understood from the following detailed description of a preferred embodiment thereof, given only by way of non-limiting example, with reference to the attached drawings, in which:

FIG. 1 is a schematic view comprising two illustrative depictions (a) and (b) of the operating principle of the lifting apparatus of the present invention;

FIG. 2 shows a top plan view of an embodiment of the apparatus of the invention, in its version with a single drive sheave and a respective suspension cable;

FIG. 3 shows a side elevation view of the same apparatus shown in FIG. 2, and

FIG. 4 is an illustrative schematic depiction of an embodiment of a lifting apparatus according to the invention, in its version with a grooved sheave and use of two suspension cables.

### DESCRIPTION OF SOME PREFERRED EMBODIMENT

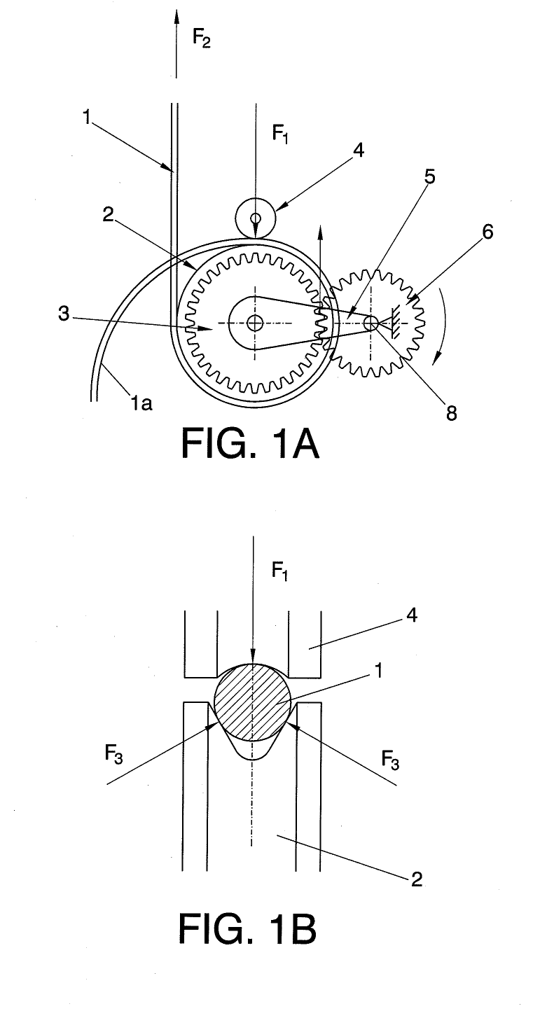

As mentioned above, the detailed description of the preferred embodiments of the invention will be given below with the aid of the attached drawings, through which the same reference numbers will be used to designate identical or similar parts. Therefore, first of all with respect to FIG. 1 of the drawings, depictions (a) and (b), illustrative diagrams of the operating principles of the apparatus of the invention can be seen. Depiction (a) of the mentioned figure shows an extended suspension cable 1 such that it passes through the peripheral groove made in a drive sheave 2 incorporating a gear wheel 3 integral with a side surface thereof, concentric with respect to the rotating shaft of said sheave 2. A pinion 6 is meshed with the mentioned gear wheel 3, being maintained in its operative position by means of a connecting rod 5 extending between the rotating shaft 8 common for said sheave 2 and associated gear wheel 3, and the rotating shaft of the pinion 6, keeping the relative distance thereof constant, this assembly being susceptible of pivoting with respect to the shaft of the pinion. The latter mentioned rotating shaft, i.e., the shaft in which said pinion 6 is mounted, is the same one in which the power unit consisting of a motor, a brake, a centrifugal brake and a reducer, is mounted. The assembly of pinch wheels of the cable has been depicted by means of a wheel 4, and the arrow F₁ represents the pressure exerted by said pinch rollers 4 on the portion of the suspension cable 1 housed in the peripheral groove of the sheave 2 and the suspension of which is carried out according to arrow F₂, whereas the section of loose cable is depicted behind the position of the rollers 4 and is indicated with reference number la.

In the representation (b) of this same figure, the behavior of the assembly when it is subjected to a load is graphically depicted. In such load conditions, the assembly pivots until contacting with the rollers 4, whereby generating a normal force between the cable 1 and the traction sheave 2. This force is precisely that one that generates sufficient adherence between the cable 1 and the sheave 2 so that the desired traction effect is performed due to the contact between said sheave 2 and the cable 1, as is graphically expressed by means of the arrows F₃ shown only by way of illustration in the same FIG. 1, representation (b). It is obvious that the balance of forces requires that the normal force created between rollers and cable is a function of the total load (tension of the cable) and of the distances to the point of rotation of the pivoting assembly. It is thus achieved that the radial load on the cable is proportional to the total load to be lifted.

In addition, as mentioned in the foregoing, it is moved by a power unit which also creates a force tending to press the traction sheave 2 against the pressure roller 4, this force being a function of the torque exerted.

The force exerted by the pressure rollers can thus be modulated, precisely adjusting it to its optimal value both from the point of view of the unwanted absence of sliding and from the point of view of greater durability of the cable.

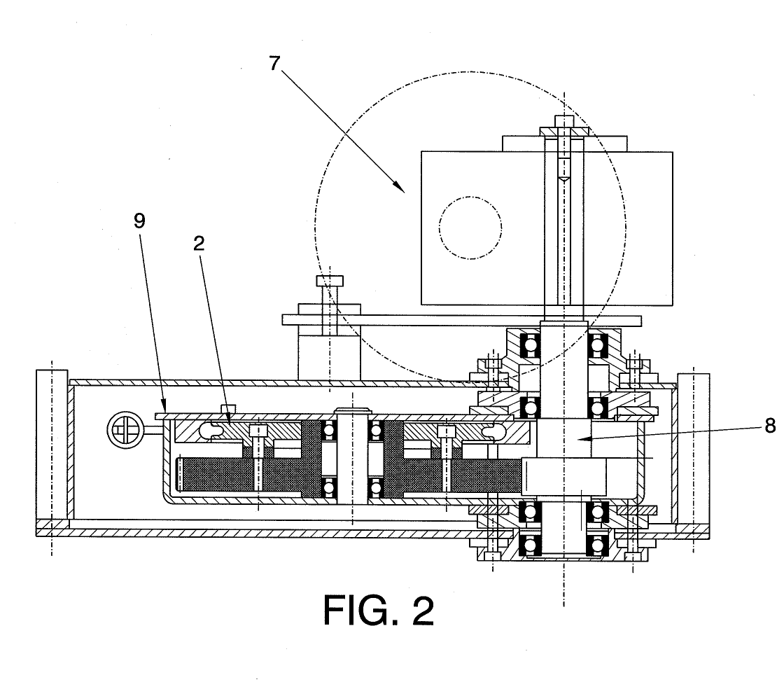

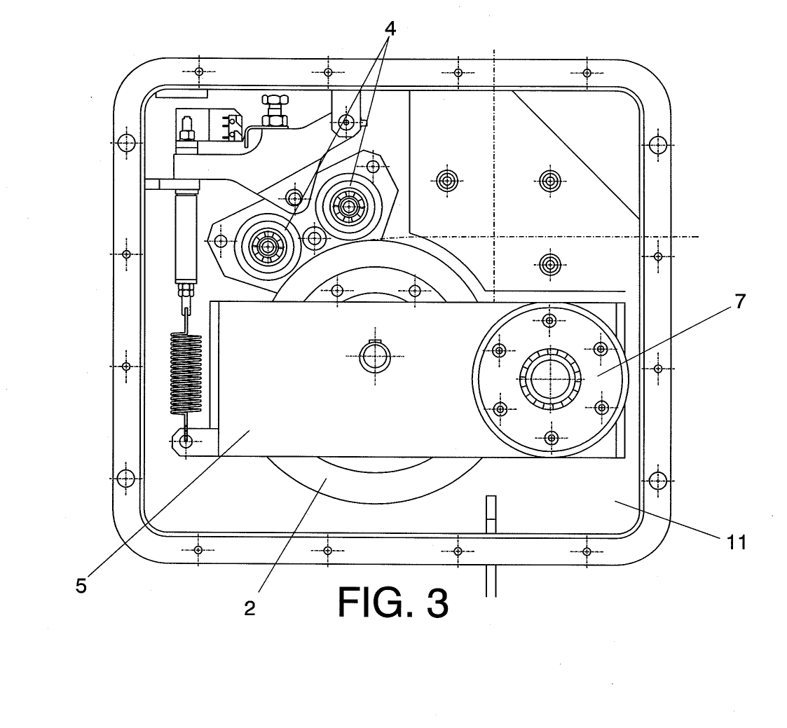

When considering the depictions shown in FIGS. 2 and 3 of the drawings, the illustration of a lifting apparatus assembly according to the invention can be seen, taken respectively in top plan and side elevation views. Both depictions show a preferred embodiment of the invention corresponding to a single cable version in which there is a sheave 2 with rollers 4 arranged to press against the suspension cable housed in the groove of said sheave. In both depictions, it can be seen in detail how the power unit 7 mentioned in the foregoing is mounted in the rotating shaft 8 and support of the pinion 6, and with respect to which the box 9 housing the described operating elements relating to a casing 11 intended for housing the different operating elements can pivot, and prepared to allow fixing thereto the load to be lifted. Other elements that are not described as they correspond with arrangements similar to those comprised in other conventional apparatuses can also be seen in the figure.

In an embodiment of the apparatus of the invention in which there are several suspension cables, it is necessary to endeavor that all the cables are subjected to identical loads. To that end, the sheave 2 can be made such that it incorporates several grooves, an independent assembly of pressure rollers 4 being arranged for each of the cables associated with each of the respective grooves. Accordingly, this modified version of the apparatus described above simply consists of repeating the implementation for a cable that is already presented as many times as there are cables to be used.

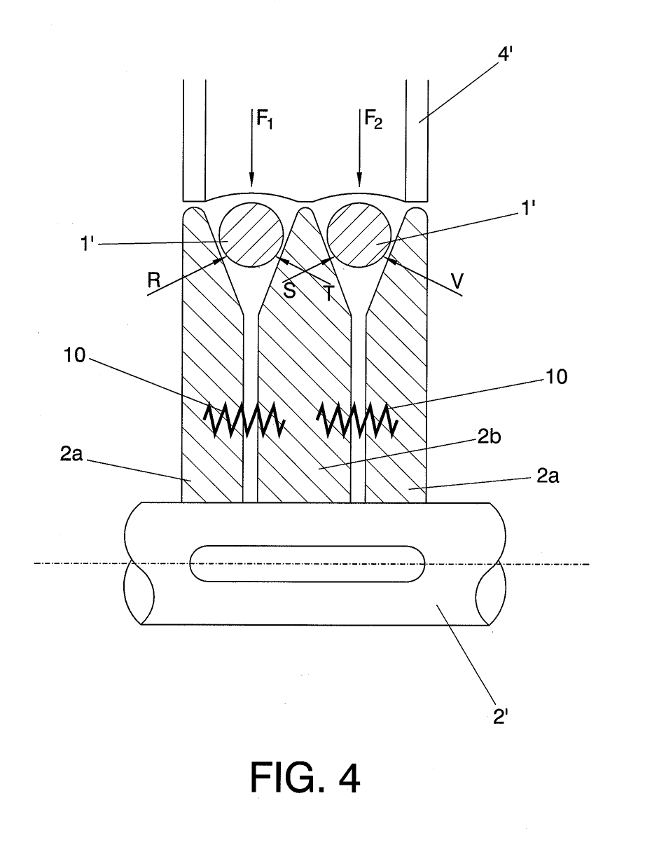

However, according to another modified version of the invention, it is possible to use several cables with a single assembly of pressure rollers 4. This modified embodiment is depicted in FIG. 4, in which by way of example two cables 1′ housed in respective grooves of a traction sheave 2′ are used, which are pressed by means of rollers 4′ configured for that purpose, these grooves being formed in peripheral areas between an intermediate portion 2b of the sheave and two side portions 2a of the sheave separated from the central portion 2b by means of notches made according to intermediate radial planes. Extending between adjacent portions there are elastic elements such as springs 10 or the like, the assembly being carried out such that the mentioned elastic elements are such that they assure that the radial forces generated on the different cables 1′ are exactly identical for the purpose of assuring a suitable distribution of forces. Since the radial forces are identical, it is also deduced that the traction forces transmitted by each of the cables will be as well, provided that the surface finish characteristics of the grooves of the sheaves are equivalent, and thereby the respective coefficients of friction.

It is not considered necessary to extend the foregoing description so that a person skilled in the art can understand its scope and the advantages derived from it, and to carry out its practical embodiment.

In any case, and since the description made corresponds solely to the preferred embodiments of the invention, within its essential features multiple variations and modifications of detail, which are equally protected, that may affect the shape, size and/or materials for manufacturing the assembly or of the parts thereof, can be made provided that the optimal behavior suitable for achieving the benefits of the invention is assured, without it entailing a departure from the essential features and scope of protection defined for same.

1. A cable lifting apparatus, intended for moving loads using a cable coupled to the peripheral groove of a traction sheave, characterized in that it comprises:
a power unit (7) made up of a motor, brake, centrifugal brake and reducer mounted in a support shaft (8);
a casing (11) susceptible of being fixed to the load to be lifted, and housing the mentioned support shaft (8);
a box (9) pivoting with respect to the shaft (8), susceptible of pivoting with respect to the mentioned casing (11), and including therein a pinion (6) coupled to the output of the reducer and meshed with a gear wheel (3) integral and rotatably concentric with the traction sheave (2), and
pressure rollers (4) fixed to the casing (11) and intended to exert suitable pressure on the load suspension cable (1) when the mentioned box (9) pivots on the mentioned shaft (8).

2. The lifting apparatus according to claim 1, characterized in that it incorporates several suspension cables (1) coupled in an equal number of respective grooves made in the periphery of a single traction sheave (2), each of the cables (1) being pressed by an independent assembly of rollers (4).

3. The lifting apparatus according to claim 1, characterized in that it incorporates several suspension cables (1′) pressed by a single assembly of rollers (4′), in which each cable (1′) is housed in a respective groove of a sheave (2′), each of the mentioned grooves being provided by means of adjacent portions (2a, 2b) successively separated by notches made according to intermediate radial planes, and elastic elements, such as springs (10), extending between contiguous portions (2a, 2b) for the purpose of assuring identical radial forces in all the cables.
